(19) United States
(12) Patent Application Publication
(10) Pub. No.: US 2026/0136283 A1
(43) Pub. Date: May 14, 2026

(54) SELECTION SYSTEM FOR SELECTING AN AMBIENT INTERNET OF THINGS DEVICE

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Antonius Hendrikus Johannes Norp, Den Haag (NL); Pascal Mathieu Agnes Marie Heijnen, Sittard (NL); Prachi Sachdeva, Den Hoorn (NL)

(21) Appl. No.: 19/119,369

(22) PCT Filed: Oct. 10, 2023
(86) PCT No.: PCT/EP2023/078073

§ 371 Date: Apr. 8, 2025

Related U.S. Application Data
(60) Provisional application No. 63/381,864, filed on Nov. 1, 2022.

(30) Foreign Application Priority Data
Dec. 1, 2022 (EP) 22210972.0

(51) Int. Cl. H04W 52/02

(52) U.S. Cl. CPC H04W 52/0225

(57) ABSTRACT

The disclosure pertains to a selection system configured to select one or more ambient Internet-of-Things, IoT, devices and to an ambient IoT device. The selection system comprises at least one power source configured to provide at least one power signal for wirelessly powering the ambient IoT devices in the area. The power signal may embed selection information configured to select one or more ambient IoT devices in the area such that the selected ambient IoT devices perform an action. The ambient IoT device is for use with a selection system and may comprise at least a power harvesting part, a processing part and a storage part configured to store selection information. The power harvesting part may be configured to harvest power from the power signal of the selection system to operate the processing part. The processing part that is powered by the power signal may be configured to determine its selection from the received selection information and the stored selection information and to perform an action only when its selection is determined.

### TECHNICAL FIELD

The present disclosure relates to a selection system, a telecommunications network comprising at least a part of the selection system and to an ambient Internet of Things, IoT, device. In particular, the disclosure relates to a selection system and a telecommunications network comprising at least a part of the selection system, wherein the selection system is configured to select one or more ambient IoT devices and to an ambient IoT device configured to be selected by the selection system.

### BACKGROUND

Over the past decades, logistics of product and service delivery have become considerably more efficient because of technological advances. For example, optical bar code scanners and information integration in logistics platforms have given rise to efficient distribution systems of products to businesses and consumers. Further progress has been made in non-visible information gathering on products in logistic chains where radio frequency identifier, RFID, tags are used storing relevant information on the products. In RFID based systems, active or passive RFID tags store information that can be retrieved from the tag using an RFID reader. Passive RFID tags are battery-less devices that harvest power from a signal of the RFID reader to enable communication of the stored information in the passive RFID tag back to the reader.

More recently, 3GPP issued a study on ambient power-enabled Internet of Things, IoT, in Technical Recommendation 3GPP TR 22.840. The document discloses use cases and requirements for ambient power-enabled IoT devices, hereinafter also referred to as ambient IoT devices, being battery-less devices with limited energy storage capability (a capacitor may be included) wherein the energy is provided through the harvesting of radio waves, light, motion, heat or any other power source that could be suitable. The study assumes that a 5G network may be used to send a discovery signal to discover ambient IoT devices within an area and that the ambient IoT device establishes communication with the 5G network to send an identity and goods information to the 5G network for further processing in a management platform.

### SUMMARY

The inventors have realized that the use cases described in TR 22.840 include situations wherein many ambient IoT devices are present in an area so that the discovery signal from the 5G network triggers many responses from the ambient IoT devices at the same time. This is inconvenient for the user of the system and may flood the 5G network with too many responses resulting in an overload of the network.

To that end, the present disclosure pertains to a selection system configured to select one or more ambient Internet-of-Things, IoT, devices from a plurality of ambient IoT devices in an area. The selection system comprises at least one power source configured to provide at least one power signal for wirelessly powering the ambient IoT devices in the area. The power signal may embed selection information configured to select one or more ambient IoT devices in the area such that the selected ambient IoT devices perform an action.

The present disclosure also relates to a telecommunications network comprising at least a part of a selection system as disclosed herein.

Furthermore, the present disclosure involves an ambient IoT device for use with a selection system as disclosed herein. In particular, the ambient IoT device may comprise at least a power harvesting part, a processing part and a storage part configured to store selection information. The power harvesting part may be configured to harvest power from the power signal of the selection system to operate the processing part. The processing part that is powered by the power signal may be configured to determine its selection from the received selection information and the stored selection information and to perform an action only when its selection is determined.

The selection system enables to target specific ambient IoT devices out of a large number of ambient IoT devices in an area to perform an action. The selection of the ambient IoT devices is performed efficiently by using the power signal that is needed to provide power to the ambient IoT device for activation. While all ambient IoT devices in the area receive power from the power signal, the disclosed selection system and ambient IoT device enable that only selected ambient IoT device may perform the action, such as initiating communication with, for example, a telecommunications network.

An example of an ambient IoT device is a device as disclosed in 3GPP TR 22.840. An ambient IoT device may be a simple battery-less device that can be attached to a product, for example as a sticker.

It should be appreciated that the selection system may be a stand-alone device, either mobile or stationary, or may be integrated in part or fully in another system, such as a telecommunications network.

In one embodiment, the selection system and ambient IoT device are configured such that the power signal comprises or consists of a single power pulse wherein the selection information is modulated in/demodulated from the single power pulse. The power pulse is a transmission or burst of energy that, at least in part, fluctuates in amplitude, frequency and/or phase to represent the selection information. One example includes a signal that starts from zero to form a preamble (e.g. a sine wave) and then embeds the signaling information as a frequency, amplitude, and/or phase variation (e.g. of the sine wave), possibly terminated by a postamble at the original (carrier) frequency before the amplitude is back to zero.

Such a selection system and ambient IoT device provide for an increased efficiency in combining powering and selection of an ambient IoT device in a single pulse. It should be appreciated that the amplitude and duration of the power pulse and the modulation thereof should be such that the ambient IoT device is able to harvest sufficient power to perform the intended action.

In one embodiment, the power signal, for example the power pulse, may include at least one of a preamble or a postamble free of selection information. The preamble may be used to power up the ambient IoT device before it is ready to receive and process the (selection) information. The postamble may be used to power the ambient IoT device for a short time after having received the selection information, e.g. to process further information and/or to perform an action for selected ambient IoT devices.

In one further embodiment, the power signal, for example the power pulse, may comprise or consist of repetitions of the selection information. For example, the power pulse may be modulated with the selection information two, three, four or five times to increase the chance that the ambient IoT device is selected if it was not yet sufficiently powered up or because of some disturbance at previous times.

In one embodiment, the selection information comprises or consists of at least one of at least one selection identifier of the one or more selected ambient IoT devices and at least one selection condition for the one or more selected ambient IoT devices.

The selection identifier in the power signal, that may, for example, be modulated in the single power pulse, may comprise an identifier of one or more ambient IoT devices, such as an individual device identifier or a group identifier. The ambient IoT device may store a selection identifier as well such that, if the ambient IoT device is powered by the power signal and subsequently determines that the identifier in the power signal corresponds to its stored identifier, the ambient IoT device may perform an instructed or preprogrammed action. Only the ambient IoT devices selected in this manner may, for example, initiate a connection to an external network so that responses are limited to the selected devices.

The selection information may comprise or consist of a selection condition. For example, the power signal, such as a single power pulse, may comprise a condition that only ambient IoT devices should respond that sense a temperature in a particular temperature range or sense a humidity above or below a particular humidity threshold. In such a situation, the ambient IoT device may comprise or be connected to a temperature or humidity sensor and read the value directly from the sensor or from memory upon receiving the power signal, such as a single power pulse, and determine whether or not to respond based on the selection condition.

It should be appreciated that the selection information may also comprise both one or more selection identifiers and one or more selection conditions.

It should be appreciated that several examples of actions are envisaged and that one or more of such actions may be performed by the powered ambient IoT device when selected as a result of further information in the power signal such as in the power pulse.

In one embodiment, the further information may comprise a reference to preprogrammed code in the ambient IoT device to execute the action. One action is to perform a local instruction on the ambient IoT device (e.g. use a sensor on or connected to the ambient IoT device) to execute a measurement, to power on something (e.g. an indicator light), to operate another member, such as an actuator or relay, to determine a location, to store information etc. It should be appreciated that the reference may be the selection information itself, i.e. the ambient IoT device automatically performs a single task programmed in the ambient IoT device upon selection. In one embodiment, the selection system is configured such that the power signal has embedded further information relating to the action. The action may pertain to storing information in the storage part of the ambient IoT device. The further information may comprise a storage instruction to store information in a storage portion of the ambient IoT device. In one embodiment, the ambient IoT device is configured to store information by the processing part in the storage part of the ambient device. The information to be stored may be (part of) the further information from the selection system or may be other information, such as information obtained via a sensor, for example a temperature sensor, a humidity sensor, a location sensor, etc. Storing of the further information may be triggered by further information, i.e. an instruction, in the power signal, such as a single power pulse.

The further information may comprise a connection instruction, for example a parameter, for initiating a connection to another device or an external network, such as a telecommunications network. The connection may be used to communicate information, such as stored or sensed values of the ambient IoT device, to an application of, for example, a logistic operator and may also be used to receive further information or instructions from the network. Connecting to another device or to the external network may be triggered by a connection instruction in the power signal, such as a single power pulse, or be the result of preprogrammed code executed by the processing part of the ambient IoT device.

The connection to another device may be useful for a variety of purposes, including storing in and/or communication via the other device, for example for relaying information. The other device may, for example, by a regulary UE or 5G-RG. Such communication via another device may be useful, for example, when the ambient IoT device cannot reach a network itself because of its limited power.

In one embodiment, the power source of the selection system is configured to provide the power signal or the single power pulse as a radio frequency electromagnetic signal or single electromagnetic power pulse. The power signal may be configured to use radio resources different from radio resources of a telecommunications network to which the ambient IoT devices are configured to initiate a connection to. This embodiment enables relatively independent operation of the selection system and the telecommunications network in view of interference of the selection system on normal operation of the telecommunications network. For example, the power signal, such as the single power pulse, may not have to be included in the radio frame structure of the telecommunications network, but can be transmitted on a different frequency and/or with a different timing than other downlink and/or uplink communications.

In one embodiment, the ambient IoT device comprises one or more sensor connections for sensors to sense one or more environmental or physical parameters, such as temperature, humidity, location, etc. Optionally, values of the one or more environment parameters may be stored in the storage part. The embodiment facilitates at least one of selection of an ambient IoT device on the basis of a selection condition embedded in the power signal, such as in the single power pulse, and to store and/or communicate sensed values to an operator.

In one embodiment, the power source of the selection system is connectable to the telecommunications network. This facilitates control from the telecommunications network over the operation of the power source to select ambient IoT devices. In such an arrangement, the power source of the selection system may be comprised in a mobile or stationary device to select devices in a coverage area and a control part of the selection system may be part of the telecommunications network. The power source of the selection system may also be integrated in the telecommunications network, such as in at least one base station of the telecommunications network, wherein the at least one base station defines a coverage area containing one or more ambient IoT devices to be selected by the selection system. The integration of the power source in the network facilitates efficient control of the power source from the telecommunications network.

In one embodiment, the telecommunications network may comprise a control system configured to control providing the power signal. The control system enables control of the selection of ambient IoT devices from the telecommunications network. The control system may be integrated in the core network part of the telecommunications network, be partly integrated in the core network and partly in a radio access network of the telecommunications network or be fully integrated in the radio access network.

In one embodiment, the control system is configured to store at least a part of the selection information for the selection system and to provide the at least a part of the selection information to the selection system to select ambient IoT device according to the selection information. By providing prestored selection information in the telecommunications network, a party can simply instruct the telecommunications network to trigger transmission of the suitable selection information in the power signal.

In one embodiment, the control system is further configured to store initiation information relating to initiating provision of the power signal from the power source, wherein the initiation information may comprise at least one of the power source or power sources that should provide the power signal, the power level of the power signal, the geographic area where power should be provided and the time and duration of when the power source or power sources should provide the power signal.

In one embodiment, the telecommunications network comprises a selection service system. The selection service system may comprise an interface for receiving input for establishing selection information. The interface may comprise at least one of an interface for subscribers of the telecommunications network and a third-party interface. The selection service system may be comprised in a core network part of the telecommunications network. The embodiment enables control of the selection system (e.g. the type of selection information to be embedded in the power signal, the further information to be embedded in the power signal, etc.) from a subscriber terminal of the telecommunications network, such as a user equipment, UE, or from a third party application accessing the selection service system over another network, such as the internet. The disclosure further relates to a selection method to select one or more ambient Internet-of-Things, IoT, devices from a plurality of ambient IoT devices in an area, wherein the selection system comprises at least one power source. The method comprises the step of providing at least one power signal for wirelessly powering the ambient IoT devices in the area, wherein the power signal has embedded selection information configured to select one or more ambient IoT devices in the area such that the selected ambient IoT devices perform an action.

The disclosure also relates to a method in a telecommunications network comprising the step of providing at least one power signal for wirelessly powering the ambient IoT devices in the area, wherein the power signal has embedded selection information configured to select one or more ambient IoT devices in the area such that the selected ambient IoT devices perform an action.

Still further, the disclosure pertains to a method in an ambient IoT device wherein the ambient device comprises at least a power harvesting part, a processing part and a storage part configured to store selection information. The method may include the steps of harvesting power from the power signal of the selection system to operate the processing part and determining selection by the processing part powered by the power signal from the received selection information and the stored selection information and to perform an action only when its selection is determined.

The disclosure also relates to a computer program comprising software code portions configured to, when executed on a computer system, cause the computer system to perform one or more of the methods defined herein, in particular in the previous paragraphs.

Finally, the disclosure pertains to a system comprising a selection system, possibly included at least in part in a telecommunications network, and an ambient IoT device. In one embodiment, of the above defined method, computer program and system, the power signal comprises or consists of a single power pulse wherein the selection information is modulated in/demodulated from the single power pulse

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIGS. 1A-1C are schematic illustrations of a selection system and an ambient IoT device according to embodiments of the invention;

FIG. 2 is a schematic illustration of an ambient IoT device comprising a plurality of functional parts according to an embodiment of the invention;

FIG. 3 is a flow chart illustrating an example for the operation of an ambient IoT device;

FIG. 4 is an example of an operation-time diagram for various parts of the ambient IoT device according to FIG. 2;

FIGS. 5A-5E are examples of power signals transmitted from the selection system and received by the ambient IoT device;

FIGS. 6A and 6B are time diagrams of operation of the selection system with or in a telecommunications network according to embodiments of the invention;

FIG. 7 is an example of a practical application of an embodiment of the disclosed selection system and ambient IoT device; and

FIG. 8 depicts an example of a processing system according to an embodiment of a selection system or a part thereof.

### DETAILED DESCRIPTION OF THE DRAWINGS

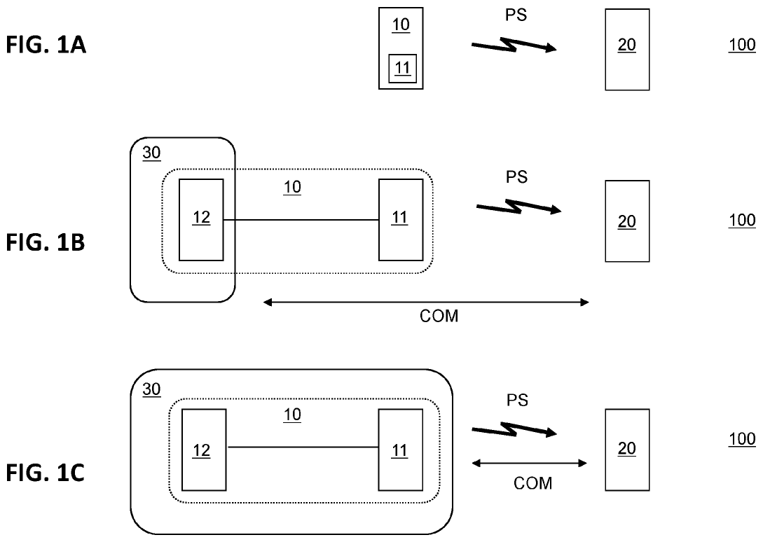

FIG. 1A is a schematic illustration of a system 100 comprising a selection system 10 and an ambient Internet of Things, IoT, device 20. The selection system 10 comprises a power source 11 configured to provide a power signal PS for wirelessly powering the ambient IoT device 20 in the area and for selecting one or more ambient IoT devices 20 based on selection information in the power signal PS. It should be appreciated that multiple ambient IoT devices 20 may be present in the system 100. In FIG. 1A, the selection system 10 is a stand-alone device. The selection device may be portable or stationary installed in the area. The power signal PS may comprise selection information and possibly other information by modulating the power signal PS. When the power signal PS is provided by a stand-alone selection system 10 (e.g. a handheld ‘gun’) it can be provisioned with the information for modulation of the power signal PS, for example by manually entering IDs and codes, or downloading the required information from a web server.

FIG. 1B is a schematic illustration of a selection system 10 and an ambient IoT device 20, wherein a portion of the selection system 10 is accommodated in a telecommunications network 30. For example, power source 11 of the selection system may be in the area of the ambient IoT device 20, whereas a (part of) a control system 12 is accommodated in the telecommunications network 30. The power source 11 may be connected to the telecommunications network 30, particularly to the control system 12, in a wireless or wired fashion. The control system 12 may be accommodated in either the radio access network or in the core network of the telecommunications network or in both. Control system 12 may be configured to control operation of power source 11 with regard to transmission of the power signal PS, such as controlling when and/or where the power signal PS is to be transmitted and/or which selection information and/or further information is to be embedded in the power signal PS.

FIG. 1C is a schematic illustration of a selection system 10 and an ambient IoT device 20, wherein the entire selection system 10 is part of a telecommunications network 30. For example, the power source 11 may be part of a radio access network, e.g. a base station, and a control system 12 may be part of a core network of the telecommunications network.

In one embodiment, the telecommunications network 30 may be a 4G, 5G or 6G network as standardized by 3GPP, or a combination thereof. For example, the base station of the telecommunications network may be a 4G basestation (an eNodeB, for example), while further components of, for example, the core network are standardized in 5G or 6G. In some embodiments, ambient IoT device 20 is configured to communicate wirelessly with the telecommunications network, as shown schematically by the thin, double-pointed arrow COM. Communication may also be directly to another device (not shown).

The power signal PS may be configured to use radio resources different from radio resources of a telecommunications network 30 to which the ambient IoT devices 20 are configured to initiate a connection to. This embodiment enables relatively independent operation of the selection system 10 and the telecommunications network 30 in view of interference of the selection system on normal operation of the telecommunications network. For example, the power signal PS may not have to be included in the radio frame structure of the telecommunications network 30 but can be transmitted on a different frequency and/or with a different timing than downlink and/or uplink communications. For example, the power signal PS may be transmitted on a radio frequency used in the communication network or in a radio frequency block that is reserved for power signals.

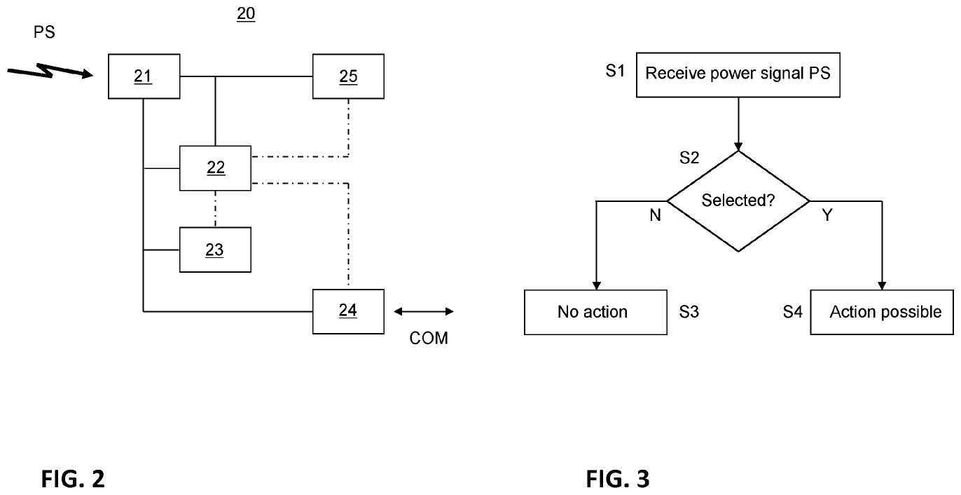

FIG. 2 is a schematic illustration of an ambient IoT device 20 configured to receive and process power signal PS. The ambient IoT device 20 comprises a power harvesting part 21, a processing part 22 and a storage part 23 configured to store, at least, selection information. The ambient IoT device 20 may, optionally, comprise at least one of a communication part 24 and at least one sensor 25 (or a connector therefore). It should be appreciated that ambient IoT device 20 may comprise a plurality of sensors 25 or connectors therefore. Examples of sensors include a location sensor, a temperature sensor, a humidity sensor, a light sensor, a pressure sensor, a motion sensor etc. A time stamp generator may also be a function available in the device, to store time stamps with the stored data.

The ambient IoT device 20 is configured to harvest power from the power signal PS of the selection system 10 to operate at least the processing part 22 and, optionally, the other parts, such as at least one of the storage part 23, communication part 24 and sensor 25. Power supply lines to these parts are indicated by the solid lines in FIG. 2.

The processing part 22 is configured to determine selection from the received selection information in the power signal PS and the selection information stored in storage part 23 and to perform an action only when its selection is determined. Signal lines for such action(s) are indicated by the dashed-dotted lines in FIG. 2.

It is appreciated that ambient IoT devices 20 may comprise more or fewer parts. Essentially, the ambient IoT device 20 is a battery-less device with limited, if any, energy storage capability (one or more capacitors may be included) wherein the energy is provided through the harvesting of radio waves, light, motion, heat or any other power source that could be suitable. The ambient IoT device 20 is not capable of storing any significant power provided to it in the power signal PS and uses the supplied power almost immediately in order to complete its desired actions.

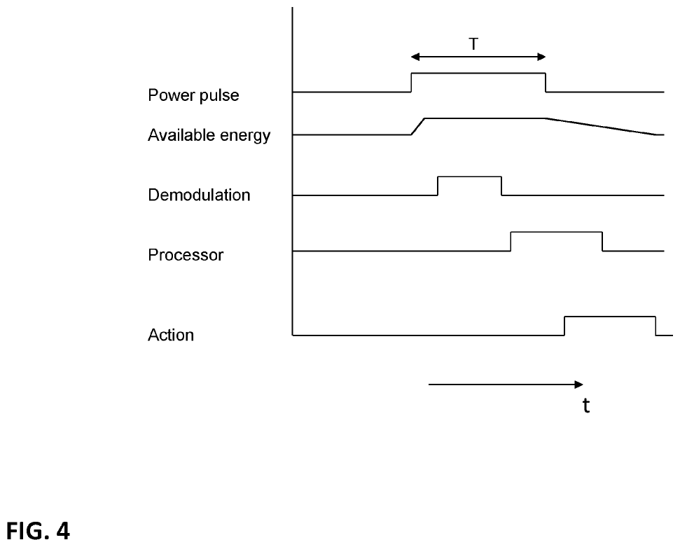

FIG. 3 is a flow chart according to a disclosed embodiment for operating the ambient IoT device 20. In a first step S1, all ambient IoT devices 20 in the area of the selection system receive a power signal PS comprising embedded selection information and are powered accordingly. Each ambient IoT device 20 receiving sufficient power from the power signal PS verifies in step S2 whether it is selected based on the selection information in the power signal PS. If it is not selected, step S3, no further actions are performed. If it is selected, step S4, the selected ambient IoT device 20 may perform an action. The ambient IoT device 20 may, for example, not respond (even when selected), respond by reading one or more attached sensors 25 and store the results in storage part 23 and/or respond by communicating with an external network (for example by a simple “I am here” message sending, for example, its identifier or by communicating more elaborate information (for example with data from one or more sensors 25), such as to the telecommunications network 30.

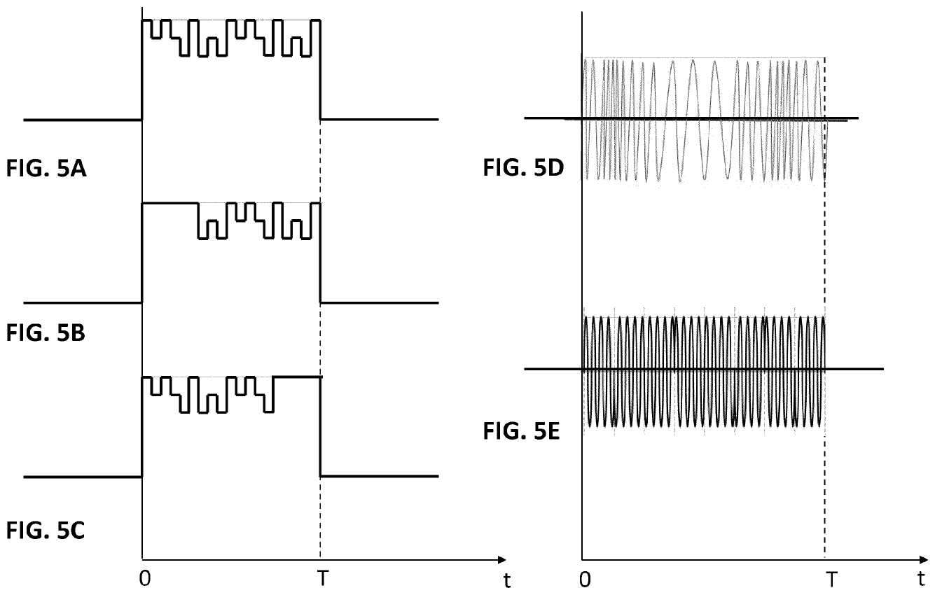

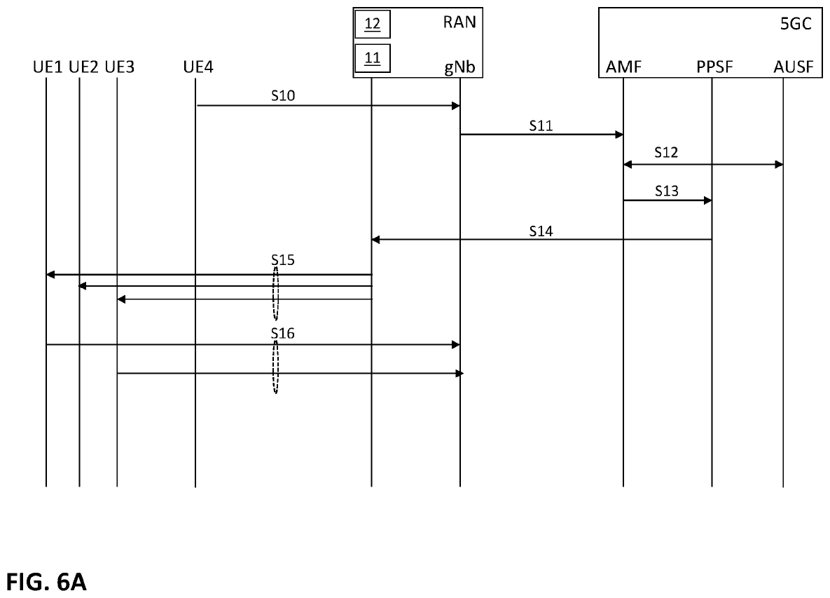

FIG. 4 is a schematic illustration of an example of subsequent operations in time for the ambient IoT device 20 of FIG. 2. Ambient IoT device 20 receives a power signal PS, such as a power pulse of duration T. The power pulse contains selection information by modulation of the pulse, as will be described in further detail with reference to FIGS. 5A-5F. From the power pulse, power harvesting part 21 collects energy and makes this energy available to other parts of the ambient IoT device 20. It should be appreciated that the available energy is generally available for a slightly longer time than the duration T of the power pulse as schematically illustrated in FIG. 4 by the slowly decreasing slope for the available energy. The available energy is used for demodulating the power pulse, which may be performed by general processing part 22 or a dedicated demodulator (not shown). The demodulation provides the selection information and processing part 22 determines from the selection information whether or not the ambient IoT device is selected (step S2 in FIG. 3). This step may involve comparison of the selection information received in the power pulse with selection information obtained from storage part 23 that is also powered by the power pulse. If selected, processing part 22 determines whether an action is to be performed. In particular, the processing part 22 may start running code from the storage part 23 in the ambient IoT device 20 and can determine (e.g. compute) whether it needs to respond and how to respond. It can, for example, collect data from sensors, or from its storage part 23 and start communication with the telecommunications network.

More generally, it should be appreciated that several examples of actions are envisaged by the inventors and that one or more of such actions may be performed by the powered ambient IoT device 20 if selected, possibly as a result of further information in the power pulse.

In one embodiment, the further information in the power pulse may comprise a reference to preprogrammed code in the storage part 23 of the ambient IoT device 20 to execute the action. One action is to perform a local instruction on the ambient IoT device (e.g. use a sensor 25 on or connected to the ambient IoT device 20) to execute a measurement, to power on something (e.g. an indicator light), to operate another member, such as an actuator or relay, to determine a location, to store information etc. It should be appreciated that the reference may be the selection information itself, i.e. the ambient IoT device 20 automatically performs a single task programmed in the ambient IoT device 20 upon selection.

In one embodiment, the selection system 10 is configured such that the power pulse has embedded further information relating to the action. The action may pertain to storing information in the storage part 23 of the ambient IoT device 20. The further information may comprise a storage instruction to store information in a storage part 23 of the ambient IoT device 20. In one embodiment, the ambient IoT device 20 is configured to store information by the processing part 22 in the storage part 23 of the ambient IoT device 20. The information to be stored may be (part of) the further information from selection system 10 or may be other information, such as information obtained via a sensor 25. Storing of the further information may be triggered by further information, i.e. an instruction, in the power pulse.

The further information may comprise a connection instruction, for example a parameter, for initiating a connection to an external network, such as a telecommunications network 30, or directly to another device that may or may not forward information to a network. The connection may be used to communicate information, such as stored or sensed values of the ambient IoT device 20, to an application of, for example, a logistic operator and may also be used to receive further information or instructions from the network 30. Connecting to the external network may be triggered by a connection instruction in the power pulse or be the result of preprogrammed code executed by the processing part of the ambient IoT device 20.

In one example, the ambient IoT device 20 is powered by a power pulse having embedded selection information comprising a (group) identification by modulating the power pulse. For example, the power pulse could be amplitude, frequency or phase modulated with the (group)identification. The ambient IoT device 20 may respond based on whether the power pulse contains the (group)identification relevant to (them) it or not. The response of the ambient IoT device 20 can be a communication action, wherein the response includes, for example “Tag no.xyz present” or for instance comprises additional sensor data resulting in a response like “Tag no.xyz present; temp. 21 deg.; humidity 65%”. It is also possible that the ambient IoT devices 20 do not need to respond at all, but only, for example, store such values after being selected.

The selection information in the power pulse may also comprise or consist of a selection condition. For example, the power pulse may comprise a condition that only ambient IoT devices 20 should respond that sense a temperature in a particular temperature range and/or sense a humidity above or below a particular humidity threshold. In such a situation, the ambient IoT device 20 may comprise or be connected to a temperature or humidity sensor 25 and read the value directly from the sensor or from memory upon receiving the power signal PS and determine whether or not to respond based on the selection condition.

FIGS. 5A-5E are examples of a single power pulse of duration T. The power pulse is a transmission or burst of energy that, at least in part, fluctuates in amplitude, frequency and/or phase to represent the selection information and, optionally, further information. It should be appreciated that before receiving the power pulse, the ambient IoT devices 20 have virtually no energy and cannot even maintain an idle state. Likewise, after the available energy harvested from the power pulse is consumed, the ambient IoT devices are incapable of performing any action, like communication or storing (sensor) data. It should be appreciated that the power pulse duration T may be varied according to the circumstances. For example, a short pulse can be chosen when only selection information needs be transmitted, whereas a longer pulse can be chosen for actions requiring more power from the ambient IoT devices 20 or when further information needs to be transmitted with the power pulse.

FIG. 5A is a single power pulse of a selection system 10 of duration T comprising selection information. Before t=0 and after t=T, the power pulse does not exist. The selection information is encoded in the power pulse by amplitude modulation for powering and selecting an ambient IoT device. The amplitude of the signal should be sufficiently high to provide sufficient available energy to enable a selected ambient IoT device to determine its selection and to perform one or more actions as desired. The amplitude modulation may not only represent the selection information but also further information, including instructions, as described above.

FIG. 5B is an illustration of a variation of a amplitude modulated power pulse, wherein the selection information and, optionally, further information, is preceded by a preamble, wherein no information is contained. The preamble may be used to power up the ambient IoT device 20 in order to prepare the ambient IoT device to read the selection information appropriately.

FIG. 5C is another variation of a single power pulse with amplitude modulated selection information followed by a postamble to continue power supply to the ambient IoT devices in the area to finalize processing. It should be appreciated that a single power pulse may contain both a pre-and postamble. It should also be appreciated that the illustrations of FIGS. 5A-5C represent the envelope of an amplitude modulated power pulse, rather than the power pulse itself which may be oscillating at a constant carrier frequency.

FIGS. 5D and 5E are further illustrations of single power pulses of duration T, wherein the selection information and, optionally, further information, is embedded using frequency modulation and phase modulation, respectively. It should be appreciated that these power pulse may also include a preamble and/or postamble by oscillating at the carrier frequency. Frequency modulation and phase modulation may be favored over amplitude modulation to provide sufficient power to the ambient IoT devices 20.

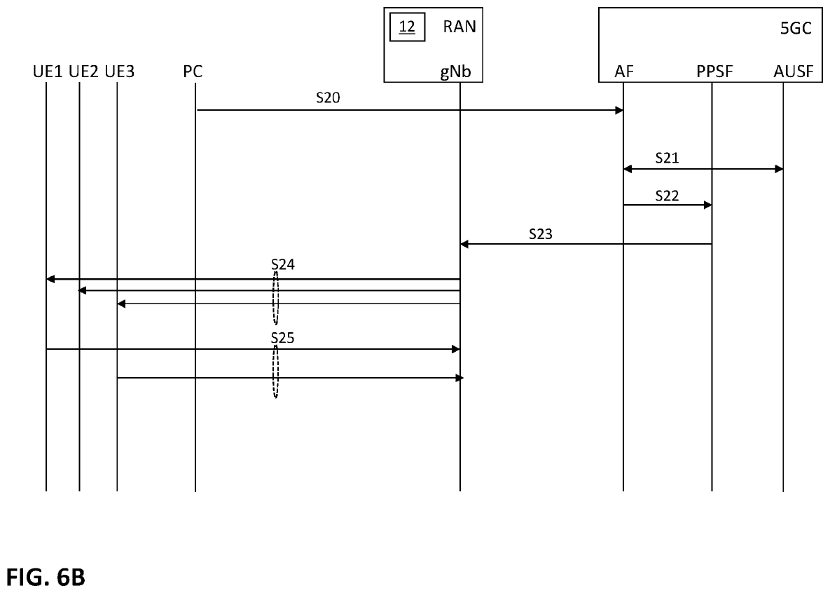

FIGS. 6A and 6B are time diagrams of operation of the selection system 10 with or within a telecommunications network 30.

In FIG. 6A, a radio access network RAN is shown comprising a plurality of base stations gNb. In addition, a power source 11 and a control system 12 are located in the area of the radio access network RAN as part of the selection system 10 of FIGS. 1A-C. The power source 11 and control system 12 are provided separate from the base stations gNb and may use radio resources different from the base station gNb to minimize interference with normal communications over the radio path for the telecommunications network 30. In other words, by using a power source 11 separate from the base stations gNB, the power pulse does not have to be included in the 5G radio frame-structure. It can be on a different frequency band and can also be completely independent from the 5G RAN in timing.

The 5G telecommunications network 30 also comprises a 5G core network 5GC. A few functions are shown for the 5GC, including an access and mobility function AMF and an authentication function AUSF. The skilled person is aware that the 5GC would generally contain further functions which have been omitted from FIGS. 6A and 6B.

The 5GC comprises a new control function, abbreviated as PPSF, for power pulse service function, to control providing the power signal PS as shown in FIGS. 1B-C as control system 12. The PPSF enables control of the selection of ambient IoT devices 20 from the telecommunications network 30. The PPSF is configured to store at least a part of the selection information of the selection system 10 and to provide the at least a part of the selection information, possibly in cooperation with a control system in the RAN, to select ambient IoT device(s) 20 according to the selection information. By providing prestored selection information in the telecommunications network 30, a party can simply instruct the telecommunications network 30 to trigger transmission of the suitable selection information in the power signal as will be described in further detail below.

The PPSF is further configured to store initiation information relating to initiating provision of the power signal from the power source 11, wherein the initiation information may comprise at least one of the power source or power sources 11 that should provide the power signal PS, the power level of the power signal PS, the geographic area where power should be provided and the time and duration of when the power source or power sources should provide the power signal PS.

The PPSF may comprise an interface for receiving input for establishing selection information and/or instructions to transmit the power signal PS. The interface may comprise at least one of an interface for subscribers of the telecommunications network, such as UE4 in FIG. 6A and a third-party interface for computer system PC in FIG. 6B (via the application function AF). The PPSF enables control of the selection system (e.g. the type of selection information to be embedded in the power signal PS, the further information to be embedded in the power signal, etc.) from an external device.

In more detail, the power source 11 is connected to the 5G core network. In a 5G system, the PPSF is an additional core network function to control the power pulse, convey or create the selection information, and determine where the power pulse has to be broadcast. The PPSF is housed in the 5GC and interfaces directly with a power source 11 in order to send a power pulse to the ambient IoT devices UE1, UE2, UE3. Ambient IoT devices UE1, UE2, UE3 may or may not contain a universal subscriber identity module UICC.

When such a power pulse is transmitted, it contains selection information that is modulated into the power pulse so that only the ambient IoT devices 20 that recognize the selection information are activated to respond to the excitation and carry out further actions, if any.

The PPSF may have full control over the nature and timing of the power pulse, i.e., the PPSF will determine where and when the pulse will be broadcast, the duration and amplitude of the power pulse, as well the selection information that needs to be modulated into the broadcasted power pulse to enable selection of the ambient IoT devices 20.

The PPSF and/or PPCF may be used to optimize provision of the power pulse in a particular area.

In FIG. 6A, the PPSF in the 5GC interfaces with a control system 12 in the radio access network RAN, which may be referred to as a Power Pulse Control Function, or PPCF. The PPCF is connected to the 5GC and to the power source 11 to control the transmission of the power pulse. Alternatively, the PPCF may be connected to one or more base stations gNB, as shown in FIG. 6B, for exciting the power pulse and provides instructions which base stations gNb need to broadcast the power pulse. The PPCF may receive the request to send out a power pulse from the PPSF and then instruct the power sources needed to cover the area where the power pulse needs to be broadcast. The request from the PPSF may also include the selection information and, optionally, further information.

Generally, there will be an operator that decides when and where to initiate a power pulse. This may be an Ambient IoT application owner, e.g. a factory owner, warehouse manager, or similar. Activation of the selection system 10 can be done on a standalone or handheld device by pushing a button or web interface (see FIG. 1A), and for other implementations the activation can be initiated in the 5GC through the AMF as shown in FIG. 6A, through an application function AF in the 5GC as shown in FIG. 6B or through a web interface to the application function AF in the 5GC.

As mentioned before, the PPSF may also have an interface to an Application Function or (third party) Application Server that interfaces to or runs the application that wants to activate the Ambient IoT devices 20. The PPSF may have a direct connection to one or more power sources 11, or may connect to the PPCF in the RAN. The responsibility of the PPCF may be to send a broadcast instruction to the different gNBs or power sources 11 in the area where the power pulse has to be broadcast.

The message flow in FIG. 6A shows a user device UE4 configured to transmit an instruction in step S10 to the telecommunications network to transmit a power PS. The user device UE4 is configured to provide an application and user interface to enable an operator to provide such instructions, for example by enabling selection of an icon corresponding to a selection of certain ambient IoT devices 20.

The instruction is received by the AMF in step S11 that performs an authentication procedure for user device UE4 with the authentication function AUTH in step S12. If the authentication passes, the instruction from user device UE4 is forwarded to the power pulse service function PPSF in step S13.

As described above, the PPSF processes the instruction from user device UE4 by determining the selection information and, optionally, further information, for modulating the power pulse as well as when and where to provide the power pulse for the targeted ambient IoT devices. In FIG. 6A, the selection information is determined to target ambient IoT devices UE1, UE3. The selection information and, optionally, further information is sent to power source 11, possibly via control system 12 in the RAN, in step S14. Step S15 indicates the broadcast of the power pulse for all ambient IoT devices UE1, UE2, UE3 in the area where the power pulse is to be transmitted. The ambient IoT devices UE1, UE2, and UE3 harvest power from the power pulse to determine its selection as illustrated in the flow chart of FIG. 3.

In step S16, only selected ambient IoT devices UE1, UE3 perform an action, i.e. to initiate communication with the telecommunications network.

Similarly, in FIG. 6B, a user device PC (a computer system such as a personal computer or a UE) is employed to initiate the power pulse by providing an instruction to an application function AF in the 5GC, step S20. After an authentication verification in step S21, the instruction is forwarded to the PPSF to determine the selection information and, optionally, further information in step S22. The PPSF provides this information to the base stations gNb (possibly via control system 12) in the RAN to transmit the power pulse in step S23 to target ambient IoT devices UE1, UE3. In step S24, these devices initiate communication with the telecommunications network.

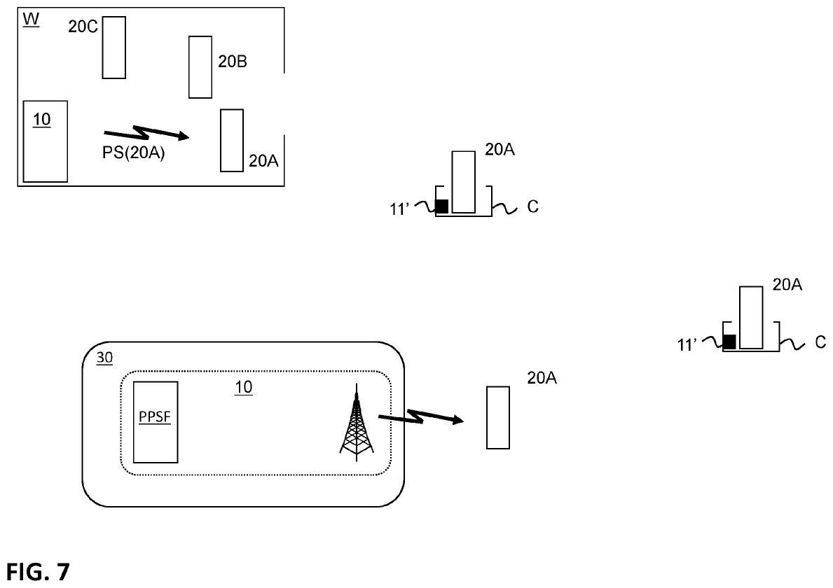

FIG. 7 is a schematical illustration of a practical example of using the selection system 10 and ambient IoT devices 20.

Warehouse W comprises a stationary selection system 10 comprising a collection of products carrying ambient IoT devices 20A, 20B, 20C. A set of products carrying IoT devices 20A is targeted from selection system 10 by transmitting power pulse PS(20A) having embedded selection information for ambient IoT devices 20A. The power pulse PS also comprises an instruction to store location information and temperature information in storage part 23 from sensors 25 at particular times (see FIG. 2).

The products carrying ambient IoT devices 20A are put on transport using a carrier C having a power source 11′. Power source 11′ may be a power source only for powering the ambient IoT devices 20A (i.e. not including the selection information), but may also be a power source embedding selection information in the power signal. For example, the power source 11′ may include selection information in the power signal to target a subset of the ambient IoT devices and instruct, for example, to also store humidity data, for products sensitive to humidity. Such instances may occur several times during transport.

On arrival, a selection system 10 embodied in a telecommunications network 30 may be applied to read the stored data from the ambient IoT devices 20A in a manner shown in FIG. 6B.

While the above exemplary embodiments use a radio frequency signal as a power signal, it should be appreciated that other signals may be used, such as light, sound, vibrations, temperature change etc. when able to provide sufficient power to ambient IoT devices having an appropriate power harvesting part to collect sufficient available energy and to determine selection. The selection information should be tailored to the applied signal.

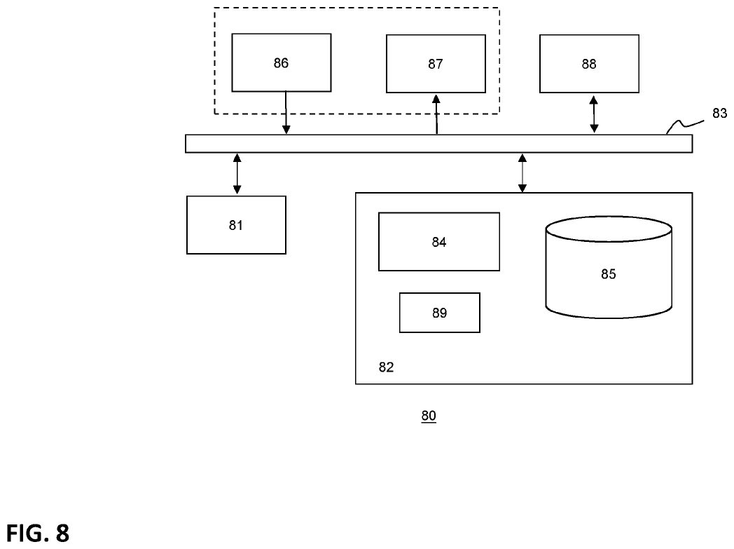

FIG. 8 depicts a block diagram illustrating an exemplary processing system according to a disclosed embodiment, e.g. a selection system 10, a user device UE4 and/or a computer system PC as described above for use in a system 100. As shown in FIG. 8, the processing system 80 may include at least one processor 81 coupled to memory elements 82 through a system bus 83. As such, the processing system may store program code within memory elements 82. Further, the processor 81 may execute the program code accessed from the memory elements 82 via a system bus 83. In one aspect, the processing system may be implemented as a computer system that is suitable for storing and/or executing program code. It should be appreciated, however, that the processing system 80 may be implemented in the form of any system including a processor and a memory that is capable of performing the functions described within this specification.

The memory elements 82 may include one or more physical memory devices such as, for example, local memory 84 and one or more bulk storage devices 85. The local memory may refer to random access memory or other non-persistent memory device(s) generally used during actual execution of the program code. A bulk storage device may be implemented as a hard drive or other persistent data storage device. The processing system 80 may also include one or more cache memories (not shown) that provide temporary storage of at least some program code in order to reduce the number of times program code must be retrieved from the bulk storage device 85 during execution.

Input/output (I/O) devices depicted as an input device 86 and an output device 87 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 8 with a dashed line surrounding the input device 86 and the output device 87). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 88 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 80, and a data transmitter for transmitting data from the processing system 80 to said systems, devices and/or networks. Modems, cable modems, and Ethernet cards are examples of different types of network adapter that may be used with the processing system 80.

As pictured in FIG. 8, the memory elements 82 may store an application 89. In various embodiments, the application 89 may be stored in the local memory 84, the one or more bulk storage devices 85, or apart from the local memory and the bulk storage devices. It should be appreciated that the processing system 80 may further execute an operating system (not shown in FIG. 8) that can facilitate execution of the application 89. The application 89, being implemented in the form of executable program code, can be executed by the processing system 80, e.g., by the processor 81. Responsive to executing the application, the processing system 80 may be configured to perform one or more operations or method steps described herein.

In one aspect of the present invention, one or more components of the base station selection support system and/or user device for use with such a base station selection support system. as disclosed herein may represent processing system 80 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 81 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A selection system configured to select one or more ambient Internet-of-Things, IoT, devices from a plurality of ambient IoT devices in an area, wherein the selection system comprises at least one power source configured to provide at least one power signal for wirelessly powering the ambient IoT devices in the area, wherein the power signal has embedded selection information configured to select one or more ambient IoT devices in the area such that the selected ambient IoT devices perform an action.

2. The selection system according to claim 1, wherein the power signal comprises a single power pulse, wherein the selection information is modulated in the single power pulse.

3. The selection system according to claim 1, wherein the selection information comprises at least one of a selection identifier of the one or more selected ambient IoT devices and a selection condition of the one or more selected ambient IoT devices.

4. The selection system according to claim 1, wherein the power signal has embedded further information relating to the action, wherein the further information optionally comprises:
a reference to preprogrammed code in a storage portion of the ambient IoT device to execute the action;
a storage instruction to store information in a storage portion of the ambient IoT device;
a connection instruction for initiating connection to a telecommunications network and/or another device.

5. The selection system according to claim 1, wherein the power source is configured to provide the power signal as a radio frequency electromagnetic signal, wherein, optionally, the power signal is configured to use radio resources different from radio resources of a telecommunications network to which the ambient IoT devices are configured to initiate a connection to.

6. A telecommunications network comprising at least a part of the selection system according to claim 1.

7. The telecommunications network according to claim 6, wherein the power source is:
connectable to the telecommunications network, or
integrated in the telecommunications network, such as in at least one base station of the telecommunications network, wherein the at least one base station defines a coverage area containing one or more ambient IoT devices to be selected by the selection system.

8. The telecommunications network according to claim 6, wherein the telecommunications network comprises a control system configured to control providing the power signal, wherein, optionally, the control system comprises a selection service system in a core network portion of the telecommunications network.

9. The telecommunications network according to claim 8, wherein the control system is configured to store at least a part of the selection information for the selection system and to provide the at least a part of the selection information to the selection system to select ambient IoT device according to the selection information.

10. The telecommunications network according to claim 8, wherein the control system is further configured to store initiation information relating to initiating provision of the power signal from the power source, wherein the initiation information may comprise at least one of the power source or power sources that should provide the power signal and when the power source or power sources should provide the power signal.

11. The telecommunications network according to claim 6, wherein the telecommunications network comprises a selection service system, wherein the selection service system comprises an interface for receiving input for establishing selection information, wherein the interface may comprise at least one of:
an interface for subscribers of the telecommunications network, and
a third-party interface.

12. An ambient IoT device for use with the selection system according to claim 1, wherein the ambient device comprises at least a power harvesting part, a processing part and a storage part configured to store selection information, wherein the power harvesting part is configured to harvest power from the power signal of the selection system to operate the processing part and the processing part powered by the power signal is configured to determine its selection from the received selection information and the stored selection information and to perform an action only when its selection is determined.

13. The ambient IoT device according to claim 12, wherein the ambient device comprise a demodulation part configured to demodulate the selection information from a single power pulse after having harvested power from the single power pulse.

14. The ambient IoT device according to claim 12, wherein the storage part contains code to perform the action after selection, wherein the action comprises at least one of:
initiating a connection with a telecommunications network by a communication part of the ambient IoT device, wherein the communication part is powered from the power harvesting part
storing information by the processing part in the storage part.

15. The ambient IoT device according to claim 12, wherein the ambient IoT device comprises one or more sensor connections for sensors to sense one or more environmental parameters, wherein values of the one or more environment parameters may be stored in the storage part or communicated with the network.
